(19) United States
(12) Patent Application Publication
(10) Pub. No.: US 2015/0281382 A1
(43) Pub. Date: Oct. 1, 2015

(54) GROUP CREATING AND JOINING METHOD, CLIENT, SERVER , AND SYSTEM

(71) Applicant: TENCENT TECHNOLOGY (SHENZHEN) COMPANY LIMITED, Shenzhen (CN)

(72) Inventors: DI XUE, Shenzhen (CN); JIAN ZHONG, Shenzhen (CN)

(73) Assignee: TENCENT TECHNOLOGY (SHENZHEN) COMPANY LIMITED

(21) Appl. No.: 14/735,144

(22) Filed: Jun. 10, 2015

Related U.S. Application Data
(63) Continuation of application No. PCT/CN2013/087788, filed on Nov. 25, 2013.

(30) Foreign Application Priority Data
Dec. 11, 2012 (CN) 2012-10530190.9

(51) Int. Cl. H04L 29/08

(52) U.S. Cl. CPC H04L 67/18; H04L 67/10

(57) ABSTRACT

The present disclosure is applicable to the field of Internet technologies, and provides a method and a system for creating and joining a group. The method includes submitting a group query request carrying a geographical identifier to a group server by using a client; and acquiring, by the group server in response to the query request, at least one location identifier matching the geographical identifier based on the geographical identifier carried in the query request, and extracting corresponding group information of one or more groups based on the matching location identifier. The method also includes sending, by the group server, the extracted group information of one or more groups corresponding to the matching location identifier to the client that submits the request; and joining, by the client, at least one of the one or more groups corresponding to the received group information.

### CROSS-REFERENCES TO RELATED APPLICATIONS

This application is a continuation application of PCT patent application no. PCT/CN2013/087788, filed on Nov. 25, 2013, which claims priority to Chinese Patent Application No. 201210530190.9, filed with the Chinese Patent Office on Dec. 11, 2012 and entitled “GROUP CREATING AND JOINING METHOD, CLIENT, SERVER, AND SYSTEM”, the content of all of which is incorporated by reference in its entirety.

### FIELD OF THE TECHNOLOGY

The present disclosure relates to the field of Internet technologies and, in particular, to a method and a system for creating and joining a group.

### BACKGROUND OF THE DISCLOSURE

With the continuous development of the instant messaging (IM) technology and social networking services (SNS) technology, groups become a multi-user communication means. The groups can effectively focus on hot topics and conveniently share user opinions, and have been more and more popular with large number of users.

In the existing technology, a group may be created based on a location based service (LBS). After the group is created in this manner, a token is generated according to certain data, such as a current location of a creating terminal of the group and group information; and the token is then broadcasted by the creating terminal, so that users in a surrounding area of the creating terminal can join the group by using the received token as a communication credential, to communicate with group members.

After a creator creates a group, the creator generally expects that a large number of users continuously join the group, so as to expand a group relationship chain and improve the degree of activity of the group. However, for the group created in such manner, the token used as a communication credential has a specific effect scope and validity period. Once the token becomes invalid, the relationship chain of the group cannot be further expanded, which lowers the group expansibility and limits the degree of activity of the group.

### SUMMARY

An embodiment of the present invention provides a method for joining a group, with the objective to solve the problem of limited expansion of a group relationship chain created based on an LBS in the existing technology.

The foregoing embodiment of the present invention is implemented as follows: A method for joining a group includes: submitting a group query request carrying a geographical identifier to a group server by using a client; acquiring, by the group server in response to the query request, at least one location identifier matching the geographical identifier based on the geographical identifier carried in the query request, and extracting corresponding group information of one or more groups based on the matching location identifier; sending, by the group server, the extracted group information of one or more groups corresponding to the matching location identifier to the client that submits the request; and joining, by the client, at least one of the one or more groups corresponding to the received group information.

An embodiment of the present invention provides a system for joining a group. The system includes a requesting client and a group server, the client is for submitting a group query request carrying a geographical identifier to the group server; the group server is for acquiring, in response to the query request, at least one location identifier matching the geographical identifier based on the geographical identifier carried in the query request, and extracting corresponding group information of one or more groups based on the matching location identifier; the group server sending the extracted group information of one or more groups corresponding to the matching location identifier to the client that submits the request; and the client is also for joining at least one of the one or more groups corresponding to the received group information.

An embodiment of the present invention provides a method for creating a group, including: submitting a group creating request carrying a geographical identifier to a group server by using a client, the creating request including a location identifier generated based on an LBS or a location identifier generated according to a user-specified location area; and creating, by the group server in response to the creating request, a group having group information including the location identifier, and storing the group information in a group database.

In the embodiments of the present invention, a group server displays group information of each group on the basis of a location identifier of each group, so that a client can obtain a group in a specific location range by query based on a location relationship and apply to join the group. In the method for joining a group provided in the embodiments of the present disclosure, group expansibility does not become invalid due to a reason that a creating client of a group leaves a group creating location, thereby ensuring sustainable expansion of a group relationship chain, and further ensuring the continuality of activity of the group.

### BRIEF DESCRIPTION OF THE DRAWINGS

FIG. 1 illustrates a block diagram of a system for performing a method for joining a group according to an embodiment of the present invention;

FIG. 2 illustrates a flowchart of a method for joining a group according to an embodiment of the present invention; and

FIG. 3 illustrates a block diagram of a system for joining a group according to an embodiment of the present invention.

### DESCRIPTION OF EMBODIMENTS

To make the objectives, technical solutions, and advantages of the present disclosure clearer, the following further describes the present disclosure in detail with reference to the accompanying drawings and the embodiments. It should be understood that the specific embodiments described herein are only used to explain the present disclosure, but not to limit the present disclosure.

In the embodiments of the present invention, a group server displays group information of each group on the basis of a location identifier of each group, so that a client can obtain a group in a specific location range by query based on a location relationship and can apply to join the group. In a method for joining a group provided in the embodiments of the present disclosure, group expansibility does not become invalid when a creating client of a group leaves a group creating location, thereby ensuring sustainable expansion of a group relationship chain, and further ensuring the continuality of activity of the group.

In the embodiments of the present invention, the group may be an IM group created in IM software, and may also be a non-IM group created based on various subjects such as a hot topic, a hobby, or a circle of friends, which is not limited herein. Any appropriate group in an online service, community, or social network may be used.

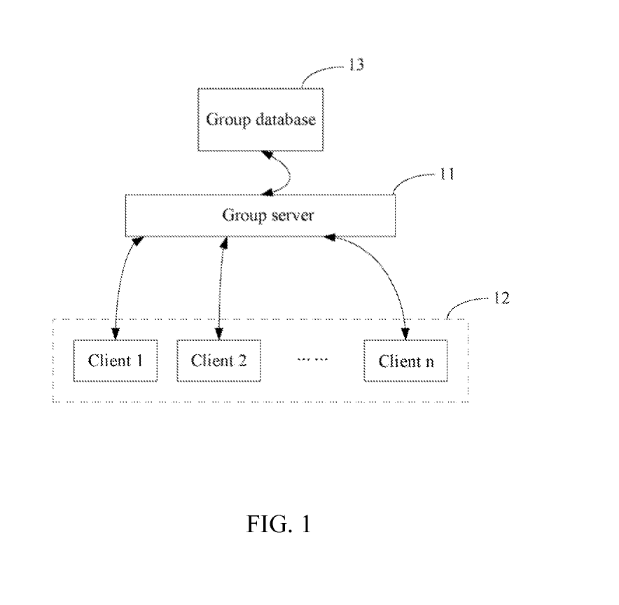

FIG. 1 shows an architectural diagram of a system applicable to a method for joining a group according to an embodiment of the present invention. For illustrative purposes, only parts related to this embodiment are shown.

Referring to FIG. 1, the system includes a group server 11 and multiple clients 12. The group server 11 manages a created group based on stored group information. The group information may be stored in a group database 13. The group information includes, but is not limited to, group data such as a group identifier, a group profile, a group member identifier, and a group location identifier.

The group server 11 performs synchronous management on a group according to the group information. The management includes, but is not limited to, group creation, group information modification, joining of a group member, dropping out of a group member, and the like. In addition, the group server 11 further provides a group query service for the clients 12, so that the clients 12 can select a created group according to a query result and apply to join the created group.

In the system, each of the clients 12 may be an application client or a webpage client, and run on a terminal device that provides a network access function, such as a personal computer, a tablet computer, or a mobile phone. The terminal device is configured to provide a running environment for the client 12 and ensure communication between the client 12 and the group server 11. Each of the clients 12 may serve as a creating client of one or more groups, and also may serve as a requesting client. The client 12 may submit a query request (or a search request) to the group server 11, and select one or more groups according to a query result (or a search result) returned by the group server 11 and apply to join the one or more groups.

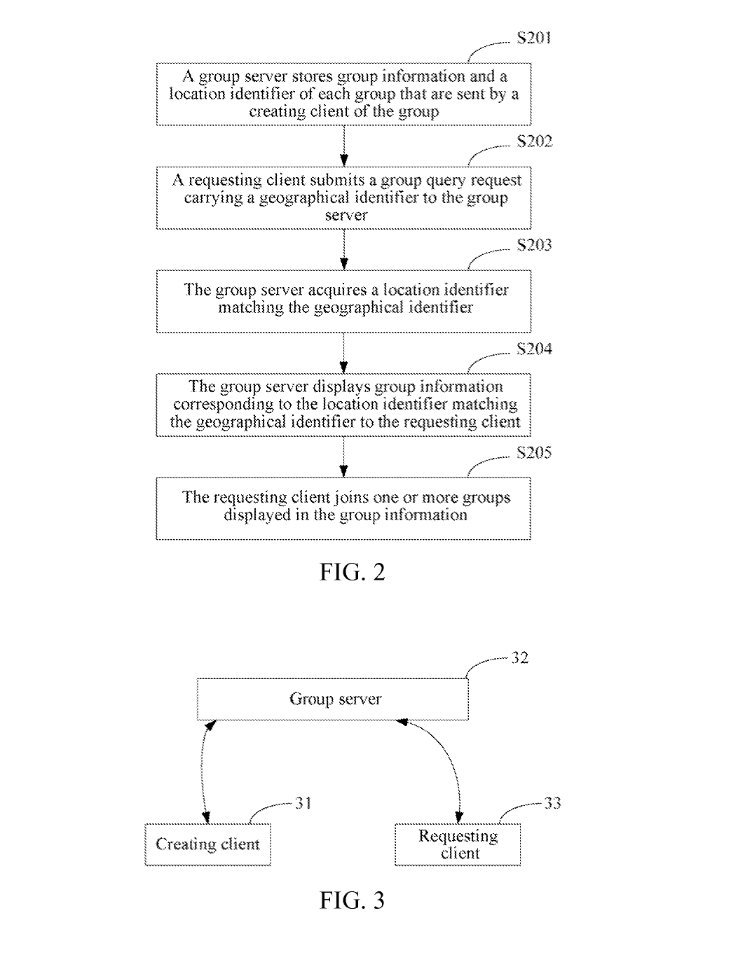

FIG. 2 shows an implementation flowchart of a method for joining a group according to an embodiment of the present invention. As shown in FIG. 2, in step S201, a group server 11 stores group information and a location identifier of each group that are sent by a creating client of the group.

After creating a group, a creating client 12 can submit group information and a location identifier of the group created by the creating client 12 to the group server 11 through a network. The group server 11 separately associates, by using a database link or a database mapping technology, group information and a location identifier of each group that are sent by a creating client of the group, and then stores the group information and the location identifier in a group database. The group information includes, but is not limited to, basic information such as a group identifier, a group profile, and group members, and the location identifier identifies a geographical location or spatial location of the group.

In this embodiment of the present invention, before step S201, the creating client of the group needs to generate the location identifier of the group. As an example of the present disclosure, when the group is created based on an LBS, the creating client generates the location identifier by means of the LBS when the group is created, where the location identifier is a geographical location at which the group is created, which is acquired through a radio communication network (such as a Global System for Mobile Communications (GSM) or a Code Division Multiple Access (CDMA) network) of the Telecom or Mobile operator or in an external location manner (such as a global positioning system (GPS)), and is represented in a form of geographical coordinate information.

As another example of the present disclosure, the location identifier may also be specified by a user by using the creating client. Specifically, the user may specify a location area on an electronic map by using the creating client; and the creating client converts geographical location information of the specified location area on the electronic map into geographical coordinate information in a backend system, thereby generating the location identifier of the group. Optionally, when a location identifier of a group is specified by a user, the user may specify multiple different location areas at the same time, and the location identifier also may include location identifiers of the multiple different location areas.

Then, in step S202, a requesting client 12 submits a group query request carrying a geographical identifier to the group server 11. In this embodiment of the present invention, the requesting client 12 submits the group query request carrying the geographical identifier to the group server 11, so as to acquire a location identifier and group information of a group that is related to the geographical identifier in terms of geographical location.

As an example of the present disclosure, the geographical identifier carried in the group query request may be generated by means of the LBS. In this case, the geographical identifier is geographical coordinate information of a current geographical location of the requesting client 12. This embodiment is applicable to a case in which a user expects to join a group whose location identifier is located near a current geographical location of the user. For example, a user travels from Shenzhen to Lijiang. During the travel, the user expects to join a group on the subject of local scenery or cultural information, so as to provide more plentiful helpful information for the travel of the user. In this case, geographical coordinate information for indicating Lijiang or a specific location of Lijiang may be directly generated by means of the LBS, so as to expect group information that is related to Lijiang in terms of the geographical location and returned by the group server according to the geographical coordinate information.

As another example of the present disclosure, the geographical identifier carried in the group query request may be not limited to the current geographical location of the requesting client, and may also be a user-specified geographical location. For example, a student B in a university A is a basketball fan, and expects to join a group that gathers basketball fans in the university A and regularly organizes basketball games on a basketball court in the university A. In this case, the student B may specify a geographical identifier “basketball court in the university A” to the requesting client 12, so as to expect group information of a group that is related to a basketball court in the university A in terms of the geographical location and returned by the group server 11 according to the specified geographical identifier. There is a large possibility that the returned group information includes the group that regularly organizes games on the basketball court.

Further, when the requesting client 12 submits the group query request carrying the geographical identifier to the group server 11, a query filter condition may also be added in the group query request, such as a group identifier keyword, the number of group members, and a group type, so that the group server can return, according to the query filter condition, group information that is more precise and better meets user requirements.

Then, in step S203, the group server 11 acquires a location identifier matching the geographical identifier. Specifically, in this embodiment, after receiving the group query request sent by the requesting client 12, the group server 11 extracts the geographical identifier carried in the group query request from the received group query request, and matches a location identifier for the geographical identifier according to a preset matching rule.

In a matching process of the group server 11, as an example of the present disclosure, when the geographical identifier in the group query request indicates the current geographical location of the requesting client generated according to the LBS, the group server 11 may acquire, according to geographical coordinates of the current geographical location of the requesting client, a location identifier in a preset area range that is centered on the current geographical location. For example, when the geographical identifier indicates a bar street in an old town of Lijiang, the group server 11 may acquire a location identifier in a 1 km area range that is centered on the bar street.

As another example of the present disclosure, when the geographical identifier in the group query request is a user-specified geographical term, the group server 11 may extract a location identifier that is the same as or has a same word segment as the geographical term. For example, when the geographical identifier is a user-specified geographical term “basketball court”, the group server 11 may extract a location identifier “basketball court”, or extract a location identifier having a word segment “basketball court”, such as “basketball court in the university A”.

Then, in step S204, the group server 11 displays group information corresponding to the location identifier matching the geographical identifier to the requesting client 12.

In this embodiment, the group server 11 acquires one or more location identifiers matching the geographical identifier and extracts, by using a data link or mapping relationship, group information of a group corresponding to the one or more location identifiers.

As an example of the present disclosure, the group server 11 may display the corresponding group information in a form of a list by using each matching location identifiers as a header. That is, the group server 11 may send the corresponding group information to the requesting client 12 to be displayed on the requesting client 12.

As another example of the present disclosure, the group server 11 may locate a group location in a location-related virtual space according to a geographical location indicated by each location identifier, and display the group information corresponding to the location identifier matching the geographical identifier. Specifically, the group server 11 may display the group information at a corresponding geographical location on an electronic map according to geographical coordinate information of the location identifier, for example, display group information of a bar at a location of the bar street of Lijiang on the electronic map.

Finally, in step S205, the requesting client 12 joins one or more groups based on the displayed group information.

As an example of the present disclosure, for one or more pieces of group information displayed by the group server 11 according to a matching result, the requesting client may directly join a group corresponding to the displayed group information.

As another example of the present disclosure, for one or more pieces of group information displayed by the group server 11 according to a matching result, the requesting client may join, by detecting a selection operation of a user, one or more groups specified by the user.

Further, the requesting client 12 needs to send a joining request to a creating client 12; and only after the creating client 12 checks the identity of the requesting client 12 and accepts the joining request of the requesting client 12, the requesting client can join a corresponding group.

In this embodiment of the present invention, a group server 11 displays group information of each group on the basis of a location identifier of each group, so that a client 12 can obtain a group in a specific location range by query based on a location relationship and apply to join the group. In the method for joining a group provided in this embodiment of the present disclosure, group expansibility does not become invalid due to a reason that a creating client 12 of a group leaves a group creating location, thereby ensuring sustainable expansion of a group relationship chain, and further ensuring the continuality of activity of the group.

FIG. 3 shows a structural block diagram of a system for joining a group according to an embodiment of the present invention. For ease of description, only parts related to this embodiment are shown.

Referring to FIG. 3, the system for joining a group includes a creating client 31, a group server 32, and a requesting client 33. Although different reference marks are used to respectively identify the requesting client and the creating client for ease of description, the two may have the same structure, and it is just that they are used to perform different tasks and therefore invokes different applications. Certainly, the two may also be enabled to have respective separate application functions.

The group server 32 is configured to store group information and a location identifier of each group that are sent by the creating client 31 of the group. The requesting client 33 is configured to submit a group query request carrying a geographical identifier to the group server 32. The requesting client 33 includes a sending module (not shown) for submitting the group query request carrying the geographical identifier to the group server; and a group joining module (not shown) for joining one or more groups corresponding to received information about an existing group.

The group server 32 acquires, based on the group query request, a location identifier matching the geographical identifier, queries based on the matching location identifier for information about an existing group, and displays the group information corresponding to the location identifier matching the geographical identifier to the requesting client 33.

Optionally, the creating client 31 is configured to generate the location identifier by means of an LBS when a group is created.

Optionally, the creating client 31 is configured to generate the location identifier according to a user-specified location area.

Optionally, the geographical identifier includes a current geographical location of the requesting client 33, and the group server 32 is configured to acquire the location identifier in a preset area range that is centered on the current geographical location.

Optionally, the geographical identifier includes a user-specified geographical term, and the group server 32 is configured to extract a location identifier that is the same as or has a same word segment as the geographical term.

Optionally, the group server 32 is specifically configured to locate a group location in a location-related virtual space according to the location identifier matching the geographical identifier, and display the corresponding group information.

Optionally, the system for joining a group further includes a group database, and the group server 32 is configured to store the group information and the location identifier of each group that are sent by the creating client 31 of the group in the group database.

In this embodiment of the present invention, a group server displays group information of each group on the basis of a location identifier of each group, so that a client can obtain a group in a specific location range by query based on a location relationship and apply to join the group. In the system for joining a group provided in this embodiment of the present disclosure, group expansibility does not become invalid due to a reason that a creating client of a group leaves a group creating location, thereby ensuring sustainable expansion of a group relationship chain, and further ensuring the continuality of activity of the group.

The foregoing descriptions are merely exemplary embodiments of the present invention, and are not intended to limit the present disclosure. Any modification, equivalent replacement, or improvement made within the spirit and principle of the present disclosure shall fall within the protection scope of the present disclosure.

What is claimed is:

1. A method for joining a group, comprising:
submitting a group query request carrying a geographical identifier to a group server by using a client;
acquiring, by the group server in response to the query request, at least one location identifier matching the geographical identifier based on the geographical identifier carried in the query request, and extracting corresponding group information of one or more groups based on the matching location identifier;
sending, by the group server, the extracted group information of one or more groups corresponding to the matching location identifier to the client that submits the request; and
joining, by the client, at least one of the one or more groups corresponding to the received group information.

2. The method according to claim 1, wherein
a location identifier is generated based on a location based service (LBS) by using the client when a group is created; or
the location identifier is generated according to a user-specified location area by using the client when the group is created.

3. The method according to claim 1, wherein the group information is stored in a group database, and the group information comprises a group identifier, a group profile, a group member identifier, and a group location identifier.

4. The method according to claim 1, wherein the geographical identifier carried in the query request is a current geographical location of the client that submits the request, and the acquiring, by the group server, at least one location identifier further comprises: acquiring, by the group server, the location identifier in a preset area range that is centered on the current geographical location.

5. The method according to claim 1, wherein the geographical identifier carried in the query request is a user-specified geographical term, and the acquiring, by the group server, at least one location identifier further comprises: extracting a location identifier that is the same as or has a same word segment as the geographical term.

6. The method according to claim 1, wherein the sending, by the group server, the extracted group information further comprises: locating, by the group server, a group location in a location-related virtual space according to the matching location identifier, and displaying the corresponding group information at the group location.

7. A system for joining a group, comprising:
a requesting client; and
a server,
wherein:
the client is for submitting a group query request carrying a geographical identifier to the group server;
the group server is for:
acquiring, in response to the query request, at least one location identifier matching the geographical identifier based on the geographical identifier carried in the query request, and extracting corresponding group information of one or more groups based on the matching location identifier; and
sending the extracted group information of one or more groups, corresponding to the matching location identifier to the client that submits the request; and
the client is also for joining at least one of the one or more groups corresponding to the received information.

8. The system for joining a group according to claim 7, wherein the location identifier is generated based on a location based service (LBS) by using a creating client when a group is created.

9. The system for joining a group according to claim 7, wherein the location identifier is generated according to a user-specified location area.

10. The system for joining a group according to claim 7, wherein the group information is stored in a group database, and the group information comprises a group identifier, a group profile, a group member identifier, and a group location identifier.

11. The system for joining a group according to claim 7, wherein the geographical identifier carried in the query request is a current geographical location of the requesting client that submits the request, and the group server is further for acquiring the at least one location identifier in a preset area range that is centered on the current geographical location.

12. The system for joining a group according to claim 7, wherein the geographical identifier carried in the query request is a user-specified geographical term, and the group server is further for extracting at least one location identifier that is the same as or has a same word segment as the geographical term.

13. The system for joining a group according to claim 7, wherein the group server is further for locating a group location in a location-related virtual space according to the matching location identifier, and displaying the corresponding group information at the group location.

14. The system for joining a group according to claim 7, the group server comprising:
a receiving module configured to receive the group query request;
a query module for acquiring, in response to the query request, the at least one location identifier matching the geographical identifier based on the geographical identifier carried in the query request, and extracting the corresponding group information; and
a sending module for sending the extracted group information to the requesting client.

15. The system for joining a group according to claim 14, the group server further comprising:
a creating module for creating, in response to a group creating request carrying a geographical identifier and received by the receiving module from a group creating client, a group having group information comprising the location identifier, and storing the group information in a group database.

16. The system for joining a group according to claim 7, the requesting client further comprising:
a sending module for submitting the group query request carrying the geographical identifier to the group server, and
a group joining module for joining the at least one of the one or more groups corresponding to the group information.

17. A method for creating a group, comprising:
submitting a group creating request carrying a geographical identifier to a group server by using a client, the creating request comprising a location identifier generated based on a location based service (LBS) or a location identifier generated according to a user-specified location area; and
creating, by the group server in response to the creating request, a group having group information comprising the location identifier, and storing the group information in a group database.
